(19) United States
(12) Patent Application Publication
(10) Pub. No.: US 2016/0244546 A1
(43) Pub. Date: Aug. 25, 2016

(54) DIRECT SYNTHESIS OF PH-RESPONSIVE POLYMER PARTICLES AND APPLICATION IN CONTROL RELEASE OF HYDROPHOBIC THERAPEUTIC COMPOUNDS

(71) Applicant: AGENCY FOR SCIENCE, TECHNOLOGY AND RESEARCH, Singapore (SG)

(72) Inventors: Tao HE, Singapore (SG); Sanggu KIM, Singapore (SG); Ludger Paul STUBBS, Singapore (SG)

(21) Appl. No.: 15/028,708

(22) PCT Filed: Oct. 10, 2014
(86) PCT No.: PCT/SG2014/000479

§ 371 Date: Apr. 11, 2016

(30) Foreign Application Priority Data
Oct. 11, 2013 (SG) 2013076179

(51) Int. Cl. C08F 220/34; A01N 25/28; A01N 31/02

(52) U.S. Cl. CPC C08F 220/34; A01N 31/02; A01N 25/28

(57) ABSTRACT

The present disclosure relates to a process for making a branched copolymer comprising reacting polymer monomers with macro-azo polyethylene glycol (PEG) initiators and cross-linkers, in the presence of a chain transfer agent, wherein said process comprises the step of traditional radical polymerization. The process further comprises a step of dialysis to obtain polymer nano-particles. The process further comprises the step of loading the polymer nanoparticles with a hydrophobic compound. The present disclosure also relates to the use of the polymer nanoparticles for the slow release of a hydrophobic compound in a neutral or alkaline environment or the fast release of a hydrophobic compound in an acidic environment.

### TECHNICAL FIELD

The present invention generally relates to a method for preparing pH-responsive polymer nanoparticles and their application in controlled release of therapeutic agents.

### BACKGROUND

pH-Responsive polymers are polymers whose solubility, volume, configuration and conformation can be reversibly manipulated by changes in external pH. The adjustment in pH alters the ionic interaction, hydrogen bonding, and hydrophobic interaction, resulting in a reversible microphase separation or self-organization phenomenon. As such, pH-responsive polymeric systems provide the possibility of fabricating tailorable “smart” functional materials which have been widely applied commercially.

Generally, pH-responsive polymers can be synthesized by emulsion polymerization and self-assembly of pre-synthesized block copolymers followed by cross-linking processes. However, there are a number of drawbacks associated with existing methods used to synthesize pH-responsive polymers.

Due to its well-controlled particle size distribution and structure, emulsion polymerization is one of the most popular synthetic routes for preparing vinyl-based pH-responsive polymeric systems, especially microgel systems. In contrast to bulk, solution or suspension polymerization, emulsion polymerization makes use of radical chain polymerization to produce latexes of narrow particle size distributions. The emulsion-polymerization systems are commonly composed of monomers, water, water-soluble initiator and surfactant (emulsifier). However, this method requires the removal of the surfactant either by dialysis or desorption, which may lead to coagulation or flocculation of the latex. Thus, there is a need for a method for preparing pH-responsive polymers that does not require the use of surfactants that have to be removed thereafter.

Alternatively, pH-responsive polymers can be synthesized using polymerization techniques such as anionic polymerization and group transfer polymerization (GTP). However, these polymerization techniques often require stringent reaction conditions and are restricted to a limited number of relatively non-functional monomers. Thus, there is a need for a method for preparing pH-responsive polymers that is simpler to operate and easier to scale up. There is also a need for a method for preparing pH-responsive polymers that is suitable for various functional monomers.

There is therefore a need to provide a method to synthesize pH-responsive polymers that overcomes, or at least ameliorates, one or more of the disadvantages described above.

### SUMMARY

According to a first aspect, there is provided a process for making a branched copolymer comprising reacting polymer monomers with macro-azo polyethylene glycol (PEG) initiators and cross-linkers, in the presence of a chain transfer agent, wherein said process comprises the step of traditional radical polymerization (TRP).

This process may allow the preparation of pH-responsive branched copolymers directly from various functional polymer monomers that have well-controlled structures. The synthesized pH-responsive branched copolymers may be stable (no disassembly) across a wide pH range and may have large loading and release capacity, thereby making them suitable for a wide range of industrial applications.

TRP may be a more competitive synthetic route for industrial applications compared to other living radical polymerization techniques such as atom-transfer radical polymerization (ATRP) and reversible addition fragmentation chain transfer polymerization (RAFT), due to the relatively simple reaction conditions which may consequently lead to a lower operation cost and shorter reaction time. For instance, TRP does not require the use of catalysts such as copper-based or thiol-based chain transfer agents, which are necessary in ATRP and RAFT respectively.

Additionally, TRP may be applied to a larger variety of monomers than other living radical polymerization techniques and may be used to synthesize polymers/copolymers with very high molecular weights that cannot be achieved by living radical polymerization.

In addition, due to the use of macro-azo PEG initiators, branched copolymers with well-controlled structures may be synthesized from functional monomers by TRP. PEG from the macro-azo initiators may facilitate the formation of the hydrophilic corona of the particles, which may result in the stabilization of the particles in the aqueous phase. Advantageously, better structure control may be achieved with macro-azo PEG initiators compared to other initiators such as AIBN initiators. When other initiators such as AIBN are used, copolymerization of several monomers including PEG-MA, DMAEMA and EGDMA may be necessary, which makes the process more complicated due to the different polymerization rate of these monomers.

The process may further comprise a step of dialysis to obtain polymer nanoparticles. The resultant branched copolymer nanoparticles may exhibit strong pH-responsiveness and may be stable across a wide pH range. Advantageously, the process may be a direct preparation of pH-responsive branched copolymer nanoparticles that does not require a self-assembly step.

The process may further comprise the step of loading the polymer nanoparticles with a hydrophobic compound.

In a second aspect, there is provided a polymer nanoparticle obtainable by the process as defined above. The polymer nanoparticle may be used for the slow release of a hydrophobic compound in a neutral or alkaline environment or the fast release of a hydrophobic compound in an acidic environment. Consequently, the polymer nanoparticle may exhibit good controlled-release of hydrophobic compounds. The polymer nanoparticle may have a higher loading capacity compared to highly cross-linked micro/nano gels.

### DEFINITIONS

The following words and terms used herein shall have the meaning indicated:

The word “polymer” or “polymeric” refers to a molecule having two or more monomeric repeat units. It includes linear and branched polymer structures, and also encompasses cross-linked polymers as well as copolymers (which may or may not be cross-linked), thus including block copolymers, alternating copolymers, random copolymers, and the like.

As used herein, macro-azo PEG initiators comprise macro-azo initiators linked with “PEG” chains of various molecular weights.

As used herein, polyethylene glycol or “PEG” broadly refers to a linear, multi-arm, or branched polymer backbone comprising a water-soluble and non-peptidic polymer having repeat CH₂CH₂O units. The PEG family of polymers generally exhibits the properties of solubility in water and in many organic solvents, lack of toxicity, and lack of immunogenicity. The term PEG should be understood to be inclusive and to include polyethylene glycol in any of its linear, branched or multi-arm forms, including alkoxy PEG, bifunctional PEG, forked PEG, branched PEG, pendant PEG, and PEG with degradable linkages therein.

The term “PDMAEMA” is used herein to refer to a polymeric composition of dimethylamino ethyl methacrylate (DMAEMA). In the context of this disclosure, the term “DMAEMA₂₀” indicates that there are 20 units of DMAEMA in the polymeric composition. Similarly, the terms “DMAEMA₃₀”, “DMAEMA₄₀”, “DMAEMA₆₀” and “DMAEMA₈₀” indicate that there are 30 units of DMAEMA, 40 units of DMAEMA, 60 units of DMAEMA and 80 units of DMAEMA in the polymeric composition respectively.

The term “PDEAEMA” is used herein to refer to a polymeric composition of diethylamino ethyl methacrylate (DEAEMA). In the context of this disclosure, the term “DEAEMA₂₀” indicates that there are 20 units of DEAEMA in the polymeric composition. Similarly, the terms “DEAEMA₃₀”, “DEAEMA₄₀”, “DEAEMA₆₀” and “DEAEMA₈₀” indicate that there are 30 units of DEAEMA, 40 units of DEAEMA, 60 units of DEAEMA and 80 units of DEAEMA in the polymeric composition respectively.

The term “PPEG” is used herein to refer to a polymeric composition of PEG.

The term “hydrophobic compound” is used herein to refer to a compound that is insoluble or sparingly soluble in aqueous solution. The hydrophobic compound may be selected from the group consisting of drugs, cosmeceuticals, natural antimicrobial active ingredient, pharmaceutical active ingredient or a combination thereof.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

Detailed Disclosure of Optional Embodiments

Exemplary, non-limiting embodiments of a process for making a branched copolymer will now be disclosed. The process comprises reacting polymer monomers with macro-azo polyethylene glycol (PEG) initiators and cross-linkers, in the presence of a chain transfer agent, wherein said process comprises the step of traditional radical polymerization.

Due to the use of macro-azo PEG initiators, branched copolymers with well-controlled structures may be synthesized from functional monomers by TRP. The polymer monomer may be selected from the group consisting of acrylates. The acrylate may be selected from the group consisting of dimethylamino ethyl methacrylate, diethylamino ethyl methacrylate, acrylic acid, butyl methacrylate, hydroxyethyl methacrylate, dimethylamino propyl methacrylate and derivatives thereof.

Advantageously, the resultant branched copolymers synthesized using macro-azo PEG initiators may have more ‘ordered’ and uniform structures compared to branched copolymers synthesized using AIBN as the initiator. The average molecular weight of the PEG in the macro-azo PEG initiator may be in the range of about 1,000 to about 25,000, about 1,000 to about 20,000, about 1,000 to about 15,000, about 1,000 to about 10,000, about 1,000 to about 5,000, about 2,000 to about 20,000, about 4,000 to about 20,000, about 5,000 to about 20,000, about 10,000 to about 20,000 and about 2,000 to about 15,000. The average molecular weight of the PEG in the macro-azo PEG initiator is preferably about 12,000 to about 20,000.

The cross-linker may be selected from the group consisting of ethylene glycol dimethacrylate (EGDMA), 2-isocyanatoethyl methacrylate and N,N″-methylenebis(acrylamide). The degree of branching of the branched copolymer may be controlled by varying the amount of cross-linker used. The degree of branching may be a value selected from the list consisting of about 0.3, about 0.4, about 0.5, about 0.6, about 0.7, about 0.8 and about 0.9. The degree of branching is preferably about 0.5 per polymer chain.

The chain transfer agent may be selected from the group consisting of 1-dodecanethiol (DDT), cyanomethyl benzodithioate, 1-octadecanethiol, 1-hexadecanethiol, 1-pentadecanethiol and 1-tetradecanethiol.

Controlling the ratio of cross-linker to chain transfer agent may result in the formation of soluble molecular species instead of cross-linked gels. The ratio of initiator/chain transfer agent/cross-linker may be a/b/c. The range of “a” may be selected from the group consisting of 0.05-1.0, 0.1-1.0, 0.1-0.9, 0.1-0.8, 0.1-0.7, 0.1-0.6, 0.1-0.5, 0.2-1.0, 0.2-0.9, 0.2-0.8, 0.2-0.7, 0.2-0.6, 0.2-0.5, 0.3-1.0, 0.3-0.9, 0.3-0.8, 0.3-0.7, 0.3-0.6, 0.4-1.0, 0.4-0.9, 0.4-0.8, 0.4-0.7, 0.5-1.0 0.5-0.9, 0.5-0.8 and 0.5-0.7. The range of “a” is preferably 0.5-1.0. The range of “b” may be selected from the group consisting of 0.1-2.0, 0.1-1.0, 0.1-0.8, 0.2-2.0, 0.1-1.0, 0.2-0.8, 0.3-2.0, 0.3-1.0 and 0.3-0.8. The range of “b” is preferably 0.1-0.8. The range of “c” may be selected from the group consisting of 0.05-1.0, 0.05-0.8, 0.05-0.5, 0.1-1.0, 0.1-0.9, 0.1-0.8, 0.1-0.7, 0.1-0.6, 0.1-0.5, 0.2-1.00, 2-0.9, 0.2-0.8, 0.2-0.7, 0.2-0.6, 0.2-0.5, 0.3-1.0, 0.3-0.9, 0.3-0.8, 0.3-0.7, 0.3-0.6, 0.4-1.0, 0.4-0.9, 0.4-0.8, 0.4-0.7, 0.5-1.0 0.5-0.9, 0.5-0.8 and 0.5-0.7. The range of “c” is preferably 0.1-0.5.

The process may further comprise the step of dialysis to obtain polymer nanoparticles. The resultant branched copolymer nanoparticles may exhibit strong pH-responsiveness and may be stable across a wide pH range. Advantageously, the process may be a direct preparation of pH-responsive branched copolymer nanoparticles that does not require a self-assembly step.

The polymer nanoparticles may exhibit pH-responsiveness across the pH range of about 1.0 to about 14.0. The range of the pH may be selected from the group consisting of about 2.0 to about 13.0, about 2.0 to about 12.0, about 3.0 to about 12.0, about 4.0 to about 14.0, about 4.0 to about 12.0, about 3.0 to about 11.0 and about 3.0 to about 10.0. The range of pH is preferably about 3.0 to about 12.0.

The polymer nanoparticles may have an average particle size selected from the group consisting of about 10 nm to about 5000 nm, about 100 nm to about 5000 nm, about 20 nm to about 3000 nm, about 30 nm to about 3000 nm, about 40 nm to about 2000 nm, about 50 nm to about 3000 nm, about 60 nm to about 3000 nm, about 20 nm to about 2000 nm, about 30 nm to about 2000 nm, about 40 nm to about 2000 nm, about 50 nm to about 2000 nm, about 60 nm to about 2000 nm, about 60 nm to about 1800 nm, about 60 nm to about 1600 nm, about 60 nm to about 1400 nm and about 40 nm to about 1800 nm. The average particle size of the polymer nanoparticle is preferably in the range of about 60 nm to about 1600 nm.

The process may further, comprise the step of loading the polymer nanoparticles with a hydrophobic compound. The hydrophobic compound may be selected from the group consisting of drugs, cosmeceuticals and a combination thereof. The hydrophobic drug may be selected from the group consisting of anticancer agent, antibiotic agent, antimicrobial agent and a combination thereof.

The anticancer agent may be selected from the group consisting of cisplatin, Vinblastine, Vincristine, Pacitaxel, 5-fluorouracil, arabinosylcytosine, gemcitabine and methotrexate.

The antibiotic may be selected from the group consisting of cefotaxime, spectinomycin, amikacin, gentamicin, neomycin and vancomycin.

The antimicrobial agent may be selected from the group consisting of terpene hydrocarbons, terpene alcohols, alcohols, aldehydes and ketones. The terpene hydrocarbon may be selected from the group consisting of limonene, pinene, camphene, terpinene and cineol. The terpene alcohol may be selected from the group consisting of geraniol, nerol, terpinen-4-ol, linalool, citronellol and terpineol. The alcohol may be selected from the group consisting of menthol, eugenol and phenol. The aldehyde may be selected from the group consisting of benzaldehyde, cinnamic aldehyde and perillaldehyde. The ketone may be selected from the group consisting of carvone, menthone and cyclohexanone.

The hydrophobic cosmeceutical may be selected from the group consisting of carotenoids, polyphenols, therapeutic plant essential oil and extracts. The carotenoid may be selected from the group consisting of beta-carotene, lycopene, lutein, zeaxanthin, and astaxanthin. The polyphenol may be selected from the group consisting of anthocyanidins, catechins, flavonoids, tannins, and procyanidins. The therapeutic plant essential oil and extract may be selected from the group consisting of eucalyptus oil, lavender oil, tea tree oil, green tea oil, rosemary oil, patchouli oil, cedarwood atlas oil, clove leaf oil, palmarosa oil, grapefruit oil, bergamot calabrian oil, pine oil, cardamom oil, peppermint oil, cinnamon leaf oil, and ylang ylang oil.

The polymer nanoparticles may be used for the slow release of a hydrophobic compound in a neutral or alkaline environment or the fast release of a hydrophobic compound in an acidic environment. The delivery of the hydrophobic compound may be sustained for about 1 hour to about 200 hours, about 1 hour to about 190 hours, about 1 hour to about 180 hours, about 1 hour to about 170 hours, about 1 hour to about 160 hours, about 1 hour to about 150 hours, about 1 hour to about 140 hours, about 1 hour to about 120 hours, about 5 hours to about 150 hours, about 5 hours to about 100 hours, about 10 hours to about 150 hours, about 15 hours to about 100 hours, about 20 hours to about 200 hours, about 20 hours to about 150 hours and about 25 hours to about 100 hours.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic illustration depicting the process for making a branched copolymer comprising reacting polymer monomers with macro-azo polyethylene glycol (PEG) initiators and cross-linkers, in the presence of a chain transfer agent, wherein said process comprises the step of traditional radical polymerization.

FIG. 2 shows the pH-responsiveness of P(PEG/DMAEMA) branched copolymer nanoparticles.

FIG. 3 shows the pH-responsiveness of P(PEG/DEAEMA) branched copolymer nanoparticles.

FIG. 4 depicts typical DLS curves of DMA2 at different pH values.

FIG. 5 depicts typical DLS curves of DEA2 at different pH values.

FIG. 6 is a TEM image of DEA4 at pH 7.0 (scale bar: 500 nm)

FIG. 7 depicts the DLS results of P(PEG₆₀₀₀/DEAEMA₂₀₀) and P(PEG₆₀₀₀/DEAEMA₅₀₀) particles.

FIG. 8 shows the release of geraniol from various pH-responsive branched copolymer nanoparticles under different pH conditions.

### EXAMPLES

Non-limiting examples of the invention will be further described in greater detail by reference to specific Examples, which should not be construed as in any way limiting the scope of the invention.

### Materials Used for all the Examples

Dimethylamino ethyl methacrylate (DMAEMA), diethylamino ethyl methacrylate (DEAEMA) and ethylene glycol dimethacrylate (EGDMA, 98%) were purchased from Sigma-Aldrich (Minnesota, USA) and passed through an aluminium oxide (Al₂O₃) column to remove the inhibitor before use. 1-Dodecanethiol (DDT) and macro-azo PEG initiators were purchased from Wako Pure Chemical Industries, Ltd (Japan) and used as received.

### Materials Characterization Used for all the Examples

¹H NMR spectra were recorded using a Bruker AC 400 instrument. Samples were analyzed at room temperature and CDCl₃ was used as the solvent.

GPC measurements were carried out using a Waters GPC System with a Waters 515 HPLC pump, 717plus autosampler, 2414 refractive-index detector, and the following Styragel@ GPC columns arranged in series: guard, HR5E (×2, 4.6 mm ID×300 mm), HR1 and HR0.5. THF was used as eluent (flow rate: 0.3 mL/min; 40° C.), mono-dispersed PMMA standard was used to make the calibration.

Dynamic light scattering (DLS) measurements were carried out using a Malvern Nano-S DLS instrument.

Transmission Electron Microscopy (TEM) measurements were analysed using a Tecnai Spirit transmission electron microscope (Tecnai G2 12) with an accelerating voltage of 110 kV. Sample solutions were dropped onto 400 mesh copper TEM grids, and dried overnight at room temperature. Multiple image sampling was undertaken over several areas of the TEM grid to ensure that the analysis was representative of the nature of the sample.

### Example 1

### Synthesis of Branched Copolymers

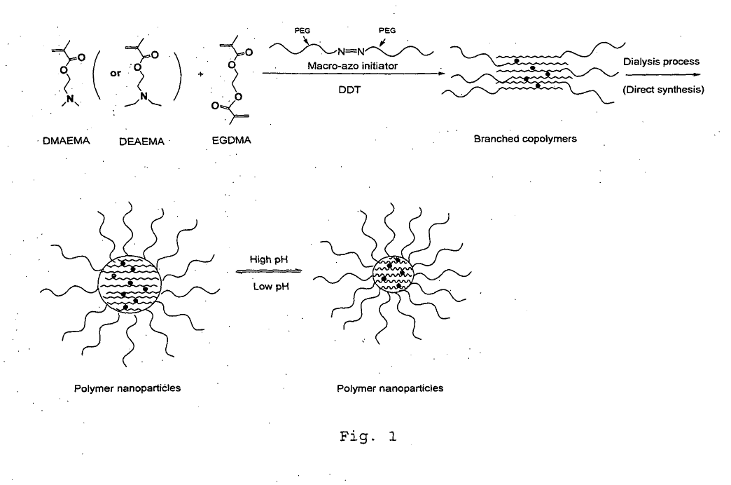

As illustrated in FIG. 1, branched copolymers of poly(poly(ethylene glycol)/dimethylamino ethyl methacrylate) (P(PEG/DMAEMA) and poly(poly(ethylene glycol)/diethylamino ethyl methacrylate) (P(PEG/DEAEMA) were synthesized via traditional radical polymerization (TRP) using a macro-azo PEG initiator in the presence of the cross-linker, ethylene glycol dimethacrylate (EGDMA), and chain transfer agent, DDT.

As a representative example for a typical polymerization process, the synthesis of DMA1 is described as follows:

MAI6000 (1 g, 0.0833 mmol) was added into a dry 50 mL Schlenk flask. The Schlenk flask was then sealed with a rubber septum and subjected to a vacuum to remove any gases and water, and then refilled with argon. This cycle was repeated three times to ensure an inert atmosphere. A solution comprising ethanol (6 mL, 4-equivalents with respect to total mass of initiator and monomer added), DMAEMA (0.52 g, 3.33 mmol), DDT (8.5 mg, 0.04 mmol), EGDMA (8.3 mg, 0.04 mmol) and anisole (0.2 ml; internal standard for ¹H NMR) was deoxygenated by bubbling argon for approximately 40 minutes. The deoxygenated solution was then added to the Schlenk flask using an argon-purged syringe. The resultant mixture was heated to 70° C. and the polymerization was carried out for 20 hours at 70° C. Monomer conversions were determined by ¹H NMR spectroscopy by comparing the integrals of the protons of the unreacted monomer with the inert internal standard. After 20 hours, the flask was cooled down to room temperature. Subsequently, an excess amount of hexane was added to the reaction mixture, which led to precipitation of the product. The precipitated solid was filtered and washed with cold hexane three times before drying under vacuum at 40° C. for two days to obtain a white powder.

Table 1 shows the various branched copolymer compositions synthesized using macro-azo PEG with varied molecular weights of PEG. Macro-azo initiators with different molecular weights of PEG were used to produce branched copolymers with varied PEG molecular weights. DDT was chosen as the chain transfer agent to prevent cross-linking, while the ratio of monomer to initiator was varied to control the molecular weight of the resultant branched copolymer. It was advantageously found that high yields were obtained for all these polymerizations, as indicated by the high conversion (>92%).

Control experiments were carried out to investigate the effect of EGDMA and DDT on the resultant branched copolymer. It was found that increasing the proportion of EGDMA resulted in the formation of undesirable cross-linked gels with limited solubility in organic solvents. Thus, it was found that the ratio of EGDMA to DDT could be controlled so as to produce soluble molecular species instead of cross-linked gels. Advantageously, the ratio of initiator/DDT/EGDMA was maintained at 1/0.5/0.5 as this led to the formation of branched copolymers that were readily soluble in common organic solvents such as tetrahydrofuran (THF) and dichloromethane (DCM).

TABLE 1
Typical branched copolymers synthesized from DMAEMA
and DEAEMA in the presence of macro-azo initiator
with DDT as chain transfer agent and EGDMA as cross-
linker (Initiator/DDT/EGDMA: 1/0.5/0.5)

| | Macro-azo | Monomer | Copolymer |
|---|---|---|---|
| Sample | initiator | used | composition |
| DMA1 | MAI6000^{a} | DMAEMA | P(PEG₆₀₀₀/DMAEMA₂₀) |
| DMA2 | MAI6000 | DMAEMA | P(PEG₆₀₀₀/DMAEMA₃₀) |
| DMA3 | MAI6000 | DMAEMA | P(PEG₆₀₀₀/DMAEMA₄₀) |
| DMA4 | MAI6000 | DMAEMA | P(PEG₆₀₀₀/DMAEMA₆₀) |
| DMA5 | MAI6000 | DMAEMA | P(PEG₆₀₀₀/DMAEMA₈₀) |
| DMA6 | MAI4000^{b} | DMAEMA | P(PEG₄₀₀₀/DMAEMA₂₀₎ |
| DMA7 | MAI4000 | DMAEMA | P(PEG₄₀₀₀/DMAEMA₃₀) |
| DMA8 | MAI4000 | DMAEMA | P(PEG₄₀₀₀/DMAEMA₄₀) |
| DMA9 | MAI2000^{c} | DMAEMA | P(PEG₂₀₀₀/DMAEMA₂₀) |
| DMA10 | MAI2000 | DMAEMA | P(PEG₃₀₀₀/DMAEMA₃₀) |
| DEA1 | MAI6000 | DEAEMA | P(PEG₆₀₀₀/DEAEMA₂₀) |
| DEA2 | MAI6000 | DEAEMA | P(PEG₆₀₀₀/DEAEMA₃₀) |
| DEA3 | MAI6000 | DEAEMA | P(PEG₆₀₀₀/DEAEMA₄₀) |
| DEA4 | MAI6000 | DEAEMA | P(PEG₆₀₀₀/DEAEMA₆₀) |
| DEA5 | MAI6000 | DEAEMA | P(PEG₆₀₀₀/DEAEMA₈₀) |

^{a,b,c}MAI6000, MAI400, MAI2000 refer to the macro-azo PEG initiator with PEG6000, PEG4000 and PEG2000 on each side (structure shown in FIG. 1) respectively.

It was advantageously found that the resultant branched copolymers synthesized using a macro-azo PEG initiator had more ‘ordered’ and uniform structures compared to branched copolymers synthesized using AIBN as the initiator.

During the polymerization, the propagating DMAEMA (or DEAEMA) segment chains were able to branch and form chemical bonds between other growing DMAEMA (or DEAEMA) segment chains, thereby building a covalently-linked association of copolymer chains. The ratio of EGDMA to the growing polymer chain was restricted to less than one branched monomer per chain, which means that the branching is, on stoichiometric average, less than one branch per one block copolymer chain. Branch points were incorporated statistically during the growth of the DMAEMA (or DEAEMA) segment and the covalent bonding between numerous chains occurred via a concerted propagation/branching process during core formation. Thus, the degree of branching can be advantageously controlled by varying the amount of EDGMA used in the process. As a result, discrete soluble molecular species were formed without the formation of a more extended macromolecular network. Overall, this process represents a one-pot direct synthesis, where a compositionally predetermined structure can be fabricated from covalently-linked macromolecular chains.

### Example 2

### Preparation of Polymer Nanoparticles

The branched copolymers were subsequently used to prepare polymer nanoparticles using a simple dialysis process, which led to polymer nanoparticles that exhibited strong pH-responsiveness. Advantageously, the dialysis process removed any residual monomers or initiator residues and led to the generation of aqueous solutions. Dynamic light scattering (DLS) was used to investigate the solution behaviour of the branched copolymers.

As a representative example for a typical dialysis process, the synthesis of polymer nanoparticles using branched block copolymer P(PEG₆₀₀₀/DMAEMA₄₀) (DMA3, Table 1) is described as follows:

The branched block copolymer P(PEG₆₀₀₀/DMAEMA₄₀) (DMA3) was dissolved in THF at 2.0 mg/ml and subsequently dialysed against water for two days (7000 g/mol Mw cut-off dialysis tubing). Gravimetric determinations showed that the amount of material removed during the dialysis process was very small as such, dialysis did not lead to significant fractionation of the polymer. No THF could be detected in the resulting dialysed solution and the solution was stable for at least two months when stored at ambient temperature, as indicated by the absence of cloudiness or precipitation.

It was found that branched copolymers prepared using a PEG4000 or PEG2000 macro-azo initiator precipitated out of solution after dialysis, which indicated that no nanoparticles were formed. This may be due to the inability of the low molecular PEG on the outer layer to stabilize the whole molecular species in water.

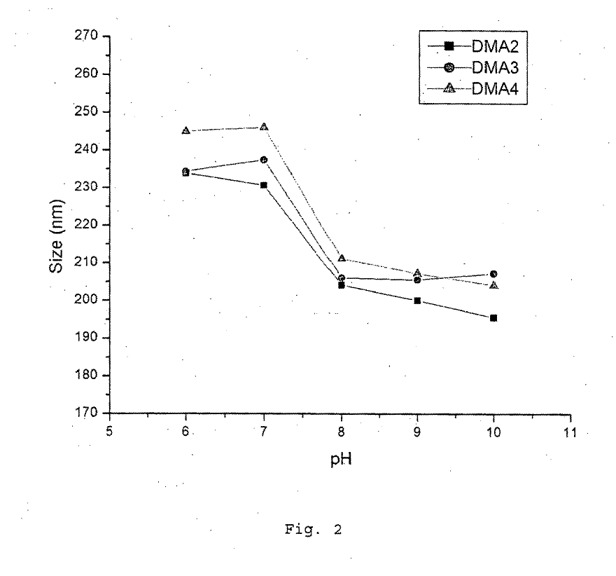

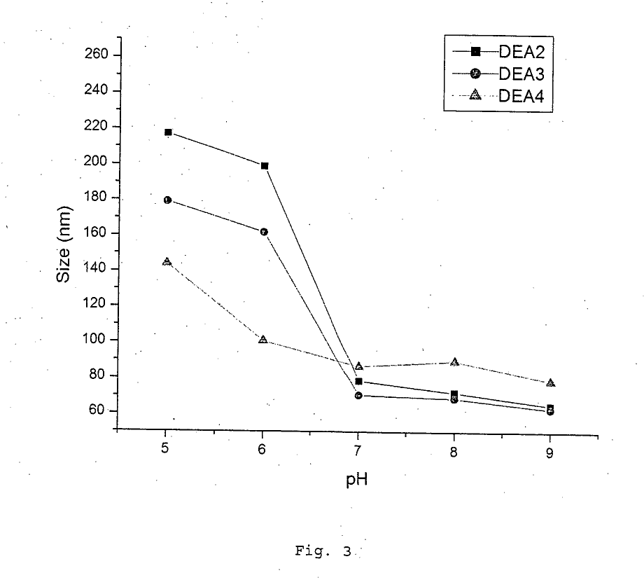

On the other hand, clear solutions were obtained from PEG6000 derived branched copolymers after dialysis. Furthermore, the resultant polymer nanoparticles were detected by DLS with sufficient light scattered, so that accurate and reliable results may be obtained, at different molecular weights with low polydispersities across the entire pH range. As illustrated in FIGS. 2 and 3, these branched copolymer particles exhibited a characteristic pH-responsiveness: the sharp shrinkage of particles occurred at about pH 7.5 and about pH 6.5 for P(PEG/DMAEMA) and P(PEG/DEAEMA) copolymer particles respectively. Negligible changes in the particle size were observed when the pH was less than pH 7.5 for P(PEG/DMAEMA). Likewise, negligible changes in the particle size were observed when the pH was less than pH 6.5 for P(PEG/DEAEMA). Considering that the pKa of linear PDMAEMA and PDEAEMA is 7.3-7.5 and 7.0-7.3 respectively, the critical pH of the branched copolymer nanoparticles shown in FIG. 2 corresponds approximately to these values.

The branched copolymer nanoparticles in water were present as core-shell structures with PDMAEMA (or PDEAEMA) as the core and PPEG as corona, respectively, for all pH ranges. At low pH, the branched copolymers were completely protonated and solvated, but the covalently linked PDMAEMA (or PDEAEMA) were still able to scatter sufficient light, so that accurate and reliable results may be obtained, thereby indicating the formation of expanded particles. On increasing the pH, due to the deprotonation of the tertiary amine groups, the branched PDMAEMA (or PDEAEMA) blocks form hydrophobically collapsed nanoparticle cores which were stabilized by the PPEG shell, thereby resulting in compact particles (FIG. 1). As such, the conformation of the nanoparticles may be controlled by changes in external pH.

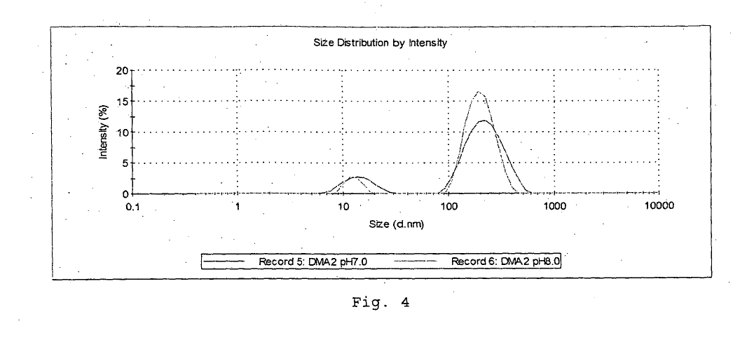

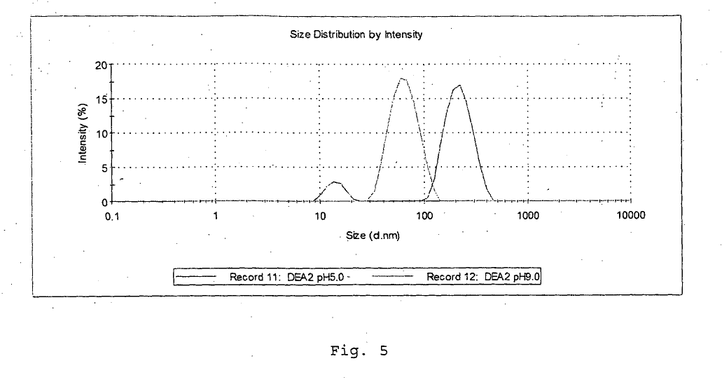

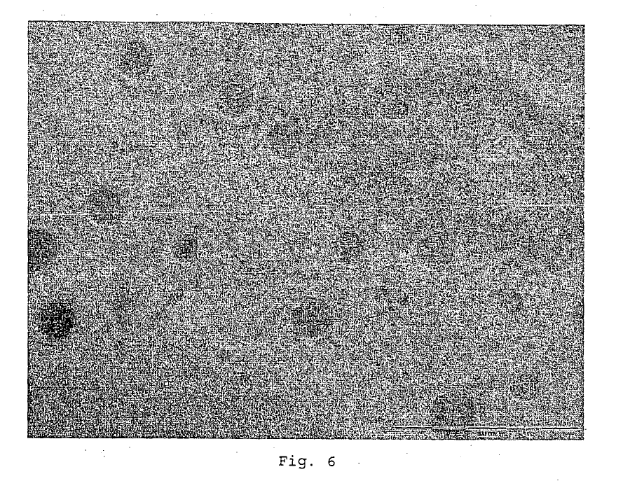

Typical DLS curves of P(PEG/DMAEMA) branched copolymer particles (DMA2 and DEA2) at different pH are shown in FIG. 4 and FIG. 5 respectively. Generally, both particle size and polydispersity decreased on increasing pH, which suggests the transformation of the expanded nanoparticles obtained under more acidic conditions to compact nanoparticles obtained under more basic conditions. From the TEM image of DEA4 at pH 7.0 (FIG. 6), it can be seen that uniform and compact nanoparticles could be obtained.

Advantageously, the use of a macro-azo PEG initiator enabled control of the structure of the branched copolymer particles. It was hypothesized and verified by control experiments that the branched copolymer particles are in a predominantly uni-molecular mode, which was a consequence of the controlled synthesis brought about by the macro-azo PEG initiator. Each particle represents one discrete molecular species with a PDMAEMA (or PDEAEMA) core and a PPEG corona. This uni-molecular structure may also be the reason for the larger particle diameters observed at low pH.

The polymeric micelle is a dynamic equilibrium and thermodynamic unstable system with a tendency to dissociate at low concentrations, while nanogels are highly cross-linked materials that typically have a cross-linking degree of more than 1.0. The branched copolymer nanoparticles were different in structure from micelles and nanogels, as the PDMAEMA (or PDEAEMA) core polymer chains were linked but the degree of branching was well controlled (as demonstrated in Example 1). As a result, in contrast to micelles, no disassembly of nanoparticles occurred while expanded nanoparticles were formed at low pH. Compared with nanogels that have a highly cross-linked core, the controlled degree of branching in the core of the branched copolymers described herein allows a relatively high loading capacity for potential applications in the controlled release of organic compounds.

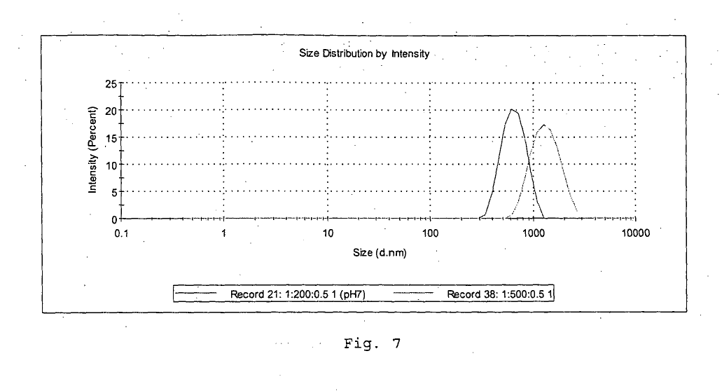

To investigate the feasibility of synthesizing micro-particles, which have higher loading capacity, branched copolymers were synthesized using a macro-azo initiator MAI6000 with varied molecular weights of PDEAEMA, followed by dialysis of the branched copolymers to form micro-particles. Typical DLS results of P(PEG₆₀₀₀/DEAEMA₂₀₀) and P(PEG₆₀₀₀/DEAEMA₅₀₀) at pH 7 are shown in FIG. 7. The molar ratio of macro-azo initiator:monomer:EGDMA was 1:200:0.5 and 1:500:0.5 for P(PEG₆₀₀₀/DEAEMA₂₀₀) and P(PEG₆₀₀₀/DEAEMA₅₀₀) respectively. The DLS results indicated that the average particle size obtained from branched copolymer P(PEG₆₀₀₀/DEAEMA₂₀₀) and P(PEG₆₀₀₀/DEAEMA₅₀₀) were 606 nm and 1198 nm, respectively. Furthermore, as shown in Table 2, the size of the micro-particles increased at lower pH, thereby indicating that the micro-particles exhibit pH-responsiveness.

TABLE 2
Synthesis of micro-particles from branched copolymers
with macro-azo initiator (MAI6000)

| | | Size(nm) | Size (nm) | Size (nm) | Size (nm) |
|---|---|---|---|---|---|
| | Copolymer | (AVE) | (D(i)90%) | (AVE) | (D(i)90%) |
| Samples | composition | At pH 7 | At pH 7 | At pH 3 | At pH 3 |
| DEA6 | P(PEG₆₀₀₀/ | 606 | 972 | 955 | 1230 |
| | DEAEMA₂₀₀) | | | | |
| DEA7 | P(PEG₆₀₀₀/ | 1198 | 2150 | 2815 | 4100 |
| | DEAEMA₅₀₀) | | | | |

### Example 3

### Loading and Release of Hydrophobic Compound

To demonstrate the loading and release ability of the pH-responsive polymer nanoparticles, geraniol (a typical fragrance and effective mosquito repellent) was loaded into various DEA nanoparticles and its release in acidic and alkaline conditions was measured.

A representative example for loading and release measurements of geraniol from branched copolymer nanoparticles is described as follows:

Branched copolymer P(PEG₆₀₀₀/DEAEMA₄₀) (0.2 g, DEA3 in Table 1) and geraniol (0.04 g) were completely dissolved in 10 mL of THF. Into this solution, deionized water (5 mL) was added dropwise at 1 drop/sec using a syringe pump under stirring. After the addition of water, the mixture was stirred for 30 minutes before the THF was removed using a gentle stream of N₂, as confirmed by ¹H NMR spectroscopy. The remaining clear aqueous solution was put into a dialysis tubing (7000 g/mol Mw cut-off), which was then put into a beaker containing 150 mL of pH 6.0 or pH 8.0 water to measure the release of geraniol. During the measurements, the whole aqueous phase was extracted using chloroform (20 mL×3 times) and GC analysis was used to detect the amount of released geraniol. Meanwhile, the dialysis, tubing containing loaded nanoparticles was placed into another 150 mL of acidic or alkaline water to continue the release of geraniol.

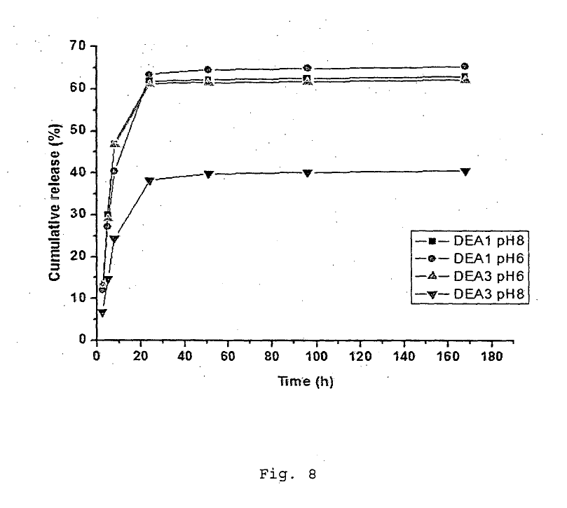

As illustrated in FIG. 8, the release of geraniol under acidic conditions was significantly faster than under alkaline conditions when a DEA3 nanoparticle was used. This is presumably due to the formation of compact nanoparticles under alkaline conditions (pH 8.0), which can encapsulate geraniol better than the corresponding expanded nanoparticles formed under more acidic conditions.

In the case of DEA1 nanoparticles, a smaller difference in the release rates of geraniol under different pH conditions was observed. However, it was still observed that the rate of release of geraniol was higher under more acidic conditions. As PDEAEMA forms the core in DEA1 nanoparticles, the relatively smaller proportion of PDEAEMA may be a contributing factor to the lower pH-responsiveness of the resultant polymer nanoparticles (20 units of PDEAEMA compared to 40 units of PDEAEMA in DEA3 nanoparticles). Conversely, the more PDEAEMA is employed, the higher the pH-responsiveness of the resultant polymer nanoparticles. As such, the pH responsiveness may be controlled by varying the amount of PDEAEMA used.

### Applications

The disclosed process is a direct preparation of pH-responsive branched polymer nanoparticles by a simple dialysis process without self-assembly. Advantageously, various functional monomers may be used and the process may be easily scaled up.

The disclosed pH-responsive polymer nanoparticles may be applied in delivery systems of hydrophobic compounds with good biological activity, stability and compatibility. In particular, when the disclosed pH-responsive polymer nanoparticles are loaded with geraniol as the hydrophobic compound, the resultant polymer nanoparticles may be potential antimicrobial agents for the treatment of skin and soft tissue to inhibit the growth of various infectious pathogens.

The release of the hydrophobic compounds may be triggered by external pH if necessary. In addition, the disclosed polymer nanoparticles are very stable across the whole pH range compared to polymer micelles that may decompose and have higher loading capacity compared to highly cross-linked micro/nano gels. Furthermore, micro-particles that have a higher loading capacity may be synthesized.

The difference in release rate under different pH conditions suggests the feasibility of applying the pH-responsive nanoparticles in fast-release systems (acidic environment) or slow-release systems (alkaline environment).

These pH-responsive polymer nanoparticles may also be used in health care and personal care (pH-triggered release, controlled-release of guest compounds such as fragrance and bioactive materials), biomedical and pharmaceutical applications (controlled release of drugs), soil remediation and environmental protection (controlled release and update of bioactive substances or in the removal of harmful materials, e.g. in waste water treatment).

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A process for making a branched copolymer comprising reacting polymer monomers with macro-azo polyethylene glycol (PEG) initiators and cross-linkers, in the presence of a chain transfer agent, wherein said process comprises the step of traditional radical polymerization.

2. The process according to claim 1, wherein said polymer monomer is selected from the group consisting of acrylates.

3. The process according to claim 1, wherein said acrylate is selected from the group consisting of dimethylamino ethyl methacrylate, diethylamino ethyl methacrylate, acrylic acid, and derivatives thereof.

4. The process according to claim 1, wherein said macro-azo PEG has varied molecular weight of PEG of between 12,000 to 20,000.

5. The process according to claim 1, wherein said cross-linker is selected from the group consisting of ethylene glycol dimethacrylate (EGDMA), 2-isocyanatoethyl methacrylate, N,N′-methylenebis(acrylamide).

6. The process according to claim 1, wherein said chain transfer agent is selected from the group consisting of 1-dodecanethiol (DDT) and cyanomethyl benzodithioate.

7. The process according to claim 1, wherein the ratio of initiator/chain transfer agent/cross-linker is a/b/c, where a=0.5-1.0; b=0.1-0.8; and c=0.1-0.5.

8. The process according to claim 1, further comprising the step of dialysis to obtain polymer nanoparticles.

9. The process according to claim 8, further comprising the step of loading the polymer nanoparticle with a hydrophobic compound.

10. The process according to claim 8, wherein the hydrophobic compound is selected from the group consisting of drugs, cosmeceuticals and a combination thereof.

11. The process according to claim 10, wherein the hydrophobic drug is selected from the group consisting of anticancer agent, antibiotic agent, antimicrobial agent and a combination thereof.

12. The process according to claim 11, wherein said anticancer agent is selected from the group consisting of cisplatin, Vinblastine, Vincristine, Pacitaxel, 5-fluorouracil, arabinosylcytosine, gemcitabine and methotrexate.

13. The process according to claim 11, wherein said antibiotic is selected from the group consisting of cefotaxime, spectinomycin, amikacin, gentamicin, neomycin and vancomycin.

14. The process according to claim 11, wherein said antimicrobial agent is selected from the group consisting of terpene hydrocarbons, terpene alcohols, alcohols, aldehydes and ketones.

15. The process according to claim 14, wherein said terpene hydrocarbon is selected from the group consisting of limonene, pinene, camphene, terpinene and cineol.

16. The process according to claim 14, wherein said terpene alcohol is selected from the group consisting of geraniol, nerol, terpinen-4-ol, linalool, citronellol and terpineol.

17. The process according to claim 14, wherein said alcohol is selected from the group consisting of menthol, eugenol and phenol.

18. The process according to claim 14, wherein said aldehyde is selected from the group consisting of benzaldehyde, cinnamic aldehyde and perillaldehyde.

19. The process according to claim 14, wherein said ketone is selected from the group consisting of carvone, menthone and cyclohexanone.

20. The process according to claim 11, wherein said cosmeceutical is selected from the group consisting of carotenoids, polyphenols, therapeutic plant essential oil and extracts.

21. The process according to claim 20, wherein said carotenoid is selected from the group consisting of beta-carotene, lycopene, lutein, zeaxanthin, and astaxanthin.

22. The process according to claim 20, wherein said polyphenol is selected from the group consisting of anthocyanidins, catechins, flavonoids, tannins, and procyanidins.

23. The process according to claim 20, wherein said therapeutic plant essential oil and extract is selected from the group consisting of eucalyptus oil, lavender oil, tea tree oil, green tea oil, rosemary oil, patchouli oil, cedarwood atlas oil, clove leaf oil, palmarosa oil, grapefruit oil, bergamot calabrian oil, pine oil, cardamom oil, peppermint oil, cinnamon leaf oil, and ylang ylang oil.

24. A polymer nanoparticle obtainable by the process according to any of claims 8 to 23.

25. The polymer nanoparticle according to claim 24, wherein said polymer nanoparticle exhibits characteristic pH-responsiveness.

26. The polymer nanoparticle according to claim 25, wherein said pH-responsiveness is across the pH range of 3.0 to 12.0.

27. The polymer nanoparticle according to claim 24, wherein said polymer nanoparticle has an average particle size of 60 to 1600 nm.

28. Use of the polymer nanoparticle obtained according to any of claims 24 to 27 for the slow release of a hydrophobic compound in neutral or alkaline environment.

29. Use of the polymer nanoparticle obtained according to any of claims 24 to 27 for the fast release of a hydrophobic compound in an acidic environment.
